(19) United States
(12) Patent Application Publication
(10) Pub. No.: US 2020/0374553 A1
(43) Pub. Date: Nov. 26, 2020

(54) IMAGE PROCESSING

(71) Applicant: SZ DJI TECHNOLOGY CO., LTD., Shenzhen (CN)

(72) Inventors: Ning MA, Shenzhen (CN); Lei ZHU, Shenzhen (CN); Ying CHEN, Shenzhen (CN)

(21) Appl. No.: 16/989,426

(22) Filed: Aug. 10, 2020

Related U.S. Application Data
(63) Continuation of application No. PCT/CN2018/076530, filed on Feb. 12, 2018.

(51) Int. Cl. H04N 19/59; H04N 19/166; H04N 19/159; H04N 19/172

(52) U.S. Cl. CPC H04N 19/59; H04N 19/172; H04N 19/159; H04N 19/166

(57) ABSTRACT

An image processing method includes generating a reference frame by changing a resolution of a reconstructed first frame, inter-encoding a second frame using the reference frame, and generating resolution change information useful for decoding the encoded second frame.

### CROSS-REFERENCE TO RELATED APPLICATION

This application is a continuation of International Application No. PCT/CN2018/076530, filed Feb. 12, 2018, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to information technology and, more particularly, to an image processing method, an image recovering method, an encoding method, a decoding method, a transmitting terminal, a receiving terminal, and a wireless transmission system.

### BACKGROUND

One of the greatest challenges in the low-transmission latency wireless video/image transmission system is that the channel conditions fluctuate over time. Adaptive image-resolution control technologies, which adapt the resolution of an image to be transmitted to the channel quality in real-time, have been used in the wireless video transmission applications to improve the transmission performance over unreliable channels. For example, when the channel bandwidth becomes smaller, the resolution of the image to be transmitted is reduced to maintain a smooth transmission. When the channel bandwidth becomes larger, the resolution of the image to be transmitted is increased to ensure a high-quality image transmission.

Conventional adaptive image-resolution control technologies generate an intra-frame by intra-encoding a current frame in response to the change of resolution between the current frame and a past frame (a neighboring frame), because an inter-frame cannot be generated due to the change of resolution between the current frame and the past frame. Since the size of an intra-frame is commonly considerably larger than an inter-frame, inserting the intra-frame into an encoded bitstream leads to a sudden increase in the size of the encoded bitstream, such that the transmission latency/delay is increased accordingly. Large fluctuations of the transmission latency cause the playback to frequently stop at the receiving terminal. Therefore, the overall perceptual quality of a video is degraded and the user experience is poor.

### SUMMARY

In accordance with the disclosure, there is provided an image processing method including generating a reference frame by changing a resolution of a reconstructed first frame, inter-encoding a second frame using the reference frame, and generating resolution change information useful for decoding the encoded second frame.

Also in accordance with the disclosure, there is provided an image recovering method including receiving resolution change information about a change in resolution in an encoded frame, generating a reference frame by changing a resolution of a decoded frame according to the resolution change information, and decoding the encoded frame using the reference frame.

Also in accordance with the disclosure, there is provided an encoding method including in response to a resolution change from a first resolution to a second resolution, obtaining an encoded first frame having the first resolution, reconstructing the encoded first frame to generate a reconstructed first frame, scaling the reconstructed first frame based on the second resolution to obtain a reference frame, and encoding a second frame using the reference frame to generate an encoded second frame having the second resolution.

Also in accordance with the disclosure, there is provided a decoding method including in response to a resolution change from a first resolution to a second resolution, obtaining a decoded first frame having the first resolution, scaling the decoded first frame based on the second resolution to obtain a reference frame, and decoding an encoded second frame using the reference frame.

Also in accordance with the disclosure, there is provided an image processing apparatus including one or more memories storing instructions and one or more processors coupled to the one or more memories. The one or more processors are configured to generate a reference frame by changing a resolution of a reconstructed first frame, inter-encode a second frame using the reference frame, and generate resolution change information useful for decoding the encoded second frame.

Also in accordance with the disclosure, there is provided an image recovering apparatus including one or more memories storing instructions and one or more processors coupled to the one or more memories. The one or more processors are configured to receive resolution change information about a change in resolution in an encoded frame, generate a reference frame by changing a resolution of a decoded frame according to the resolution change information, and decode the encoded frame using the reference frame.

Also in accordance with the disclosure, there is provided an encoding apparatus including one or more memories storing instructions and one or more processors coupled to the one or more memories. The one or more processors are configured to in response to a resolution change from a first resolution to a second resolution, obtain an encoded first frame having the first resolution, reconstruct the encoded first frame to generate a reconstructed first frame, scale the reconstructed first frame based on the second resolution to obtain a reference frame, and encode a second frame using the reference frame to generate an encoded second frame having the second resolution.

Also in accordance with the disclosure, there is provided a decoding apparatus including one or more memories storing instructions and one or more processors coupled to the one or more memories. The one or more processors are configured to in response to a resolution change from a first resolution to a second resolution, obtain a decoded first frame having the first resolution, scale the decoded first frame based on the second resolution to obtain a reference frame, and decode an encoded second frame using the reference frame.

Also in accordance with the disclosure, there is provided a wireless communication system including a transmitting terminal including a first one or more memories storing instructions and a first one or more processors coupled to the first one or more memories. The first one or more processors are configured to generate a reference frame by changing a resolution of a reconstructed first frame, inter-encode a second frame using the reference frame, and generate resolution change information useful for decoding the encoded second frame. The wireless communication system further includes a receiving terminal including a second one or more processors and a second one or more memories coupled to the second one or more processors. The second one or more processors are configured to receive resolution change information about a change in resolution in an encoded frame, generate a reference frame by changing a resolution of a decoded frame according to the resolution change information, and decode the encoded frame using the reference frame.

### BRIEF DESCRIPTION OF THE DRAWINGS

FIG. 1 is a schematic diagram showing a wireless transmission system according to exemplary embodiments of the disclosure.

FIG. 2 is a schematic diagram showing a transmitting terminal according to exemplary embodiments of the disclosure.

FIG. 3 is a schematic diagram showing a receiving terminal according to exemplary embodiments of the disclosure.

FIG. 4 is a flow chart showing an image processing method according to an exemplary embodiment of the disclosure.

FIG. 5 schematically shows upscaling and downscaling an image frame according to exemplary embodiments of the disclosure.

FIG. 6 is a schematic diagram showing inter-encoding and reconstruction processes according to exemplary embodiments of the disclosure.

FIG. 7 is a flow chart showing an image recovering method according to an exemplary embodiment of the disclosure.

FIG. 8 is a schematic diagram showing an inter-decoding process according to exemplary embodiments of the disclosure.

FIG. 9 is a flow chart showing an encoding method according to an exemplary embodiment of the disclosure.

FIG. 10 is a flow chart showing a decoding method according to an exemplary embodiment of the disclosure.

### DETAILED DESCRIPTION OF THE EMBODIMENTS

Hereinafter, embodiments consistent with the disclosure will be described with reference to the drawings, which are merely examples for illustrative purposes and are not intended to limit the scope of the disclosure. Wherever possible, the same reference numbers will be used throughout the drawings to refer to the same or like parts.

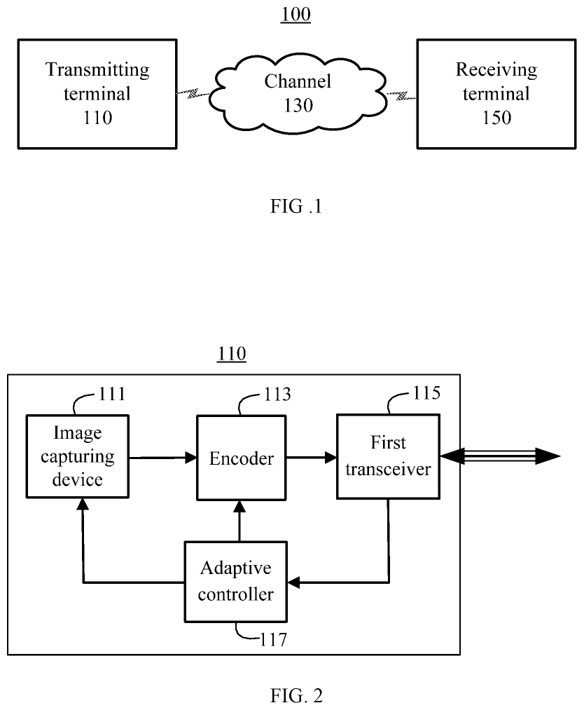

FIG. 1 is a schematic diagram showing an exemplary wireless transmission system 100 consistent with the disclosure. The wireless transmission system 100 includes a transmitting terminal 110 and a receiving terminal 150. As shown in FIG. 1, the transmitting terminal 110 is configured to transmit data to the receiving terminal 150 over a wireless channel 130. In some embodiments, the data can be in the form of a bitstream that is obtained by encoding images. The images may be still images, e.g., pictures, and/or moving images, e.g., videos. Hereinafter, the term “image” is used to refer to either a still image or a moving image.

In some embodiments, the receiving terminal 150 may be configured to send feedback information including, for example, channel information that refers to one or more parameters representing current channel conditions, such as, a signal-to-noise ratio (SNR), a signal-to-interference plus noise ratio (SINR), a bit error rate (BER), a channel quality indicator (CQI), a transmission latency, a channel bandwidth, or the like, to the transmitting terminal 110 over the wireless channel 130. The transmitting terminal 110 can perform an image processing method consistent with the disclosure, such as one of the exemplary image processing methods described below, based on the feedback information, and/or an encoding method consistent with the disclosure, such as one of the exemplary encoding methods described below.

In some embodiments, the transmitting terminal 110 can be also configured to send resolution change information to the receiving terminal 150. The receiving terminal 150 can perform an image recovering method consistent with the disclosure, such as one of the exemplary image recovering methods described below and/or a decoding method consistent with the disclosure, such as one of the exemplary decoding methods described below, based on the resolution change information.

In some embodiments, the transmitting terminal 110 may be integrated in a mobile object, such as an unmanned aerial vehicle (UAV), a driverless car, a mobile robot, a driverless boat, a submarine, a spacecraft, a satellite, or the like. In some other embodiments, the transmitting terminal 110 may be a hosted payload carried by the mobile object that operates independently but may share the power supply of the mobile object.

In some embodiments, the receiving terminal 150 may be a remote controller or a terminal device with an application (app) that can control the transmitting terminal 110 or the mobile object in which the transmitting terminal 110 is integrated, such as a smartphone, a tablet, a game device, or the like. In some other embodiments, the receiving terminal 150 may be provided in another mobile object, such as a UAV, a driverless car, a mobile robot, a driverless boat, a submarine, a spacecraft, a satellite, or the like. The receiving terminal 150 and the mobile object may be separate parts or may be integrated together.

The wireless channel 130 may use any type of physical transmission medium other than cable, such as air, water, space, or any combination of the above media. For example, if the transmitting terminal 110 is integrated in a UAV and the receiving terminal 150 is a remote controller, the data can be transmitted over air. If the transmitting terminal 110 is a hosted payload carried by a commercial satellite and the receiving terminal 150 is integrated in a ground station, the data can be transmitted over space and air. If the transmitting terminal 110 is a hosted payload carried by a submarine and the receiving terminal 150 is integrated in a driverless boat, the data can be transmitted over water.

FIG. 2 is a schematic diagram showing an exemplary transmitting terminal 110 consistent with the disclosure. The transmitting terminal 110 includes an image capturing device 111, an encoder 113, a first wireless transceiver 115, and an adaptive controller 117. The encoder 113 is coupled to the image capturing device 111, the first wireless transceiver 115, and the adaptive controller 117. The adaptive controller 117 is also coupled to the image capturing device 111 and the first wireless transceiver 115.

The image capturing device 111 includes an image sensor and a lens or a lens set, and is configured to capture images. The image sensor may be, for example, an opto-electronic sensor, such as a charge-coupled device (CCD) sensor, a complementary metal-oxide-semiconductor (CMOS) sensor, or the like. The image capturing device 111 is further configured to send the captured images to the encoder 113 for encoding. In some embodiments, the image capturing device 111 may include a memory for storing, either temporarily or permanently, the captured images.

In some embodiments, the image sensor may have a plurality of capture resolutions. The capture resolution refers to how many of pixels the image sensor uses to capture the image. That is, an image captured by the image sensor can have a resolution that equals the capture resolution of the image sensor. The maximum capture resolution can be determined by the number of pixels in the full area of the image sensor. The selection of the plurality of capture resolutions can be controlled by the adaptive controller 117, according to the channel information that is fed back to the transmitting terminal 110 by the receiving terminal 150.

The encoder 113 is configured to receive the images captured by the image capturing device 111 and encode the images to generate encoded data, also referred to as an encoded bitstream. The encoder 113 may encode the images captured by the image capturing device 111 according to any suitable video encoding standard, also referred to as video compression standard, such as Windows Media Video (WMV) standard, Society of Motion Picture and Television Engineers (SMPTE) 421-M standard, Moving Picture Experts Group (MPEG) standard, e.g., MPEG-1, MPEG-2, or MPEG-4, H.26x standard, e.g., H.261, H.262, H.263, or H.264, or another standard. In some embodiments, the selection of the video encoding standard may depend on specific applications. For example, Joint Photographic Experts Group (JPEG) standard can be used for still image compression and H.264 can be used for motion-compensation-based video compression. In some other embodiments, the video encoding standard may be selected according to the video encoding standard supported by a decoder, channel conditions, the image quality requirement, and/or the like. For example, a lossless compression standard, for example, JPEG lossless compression standard (JPEG-LS), may be used to enhance the image quality, when the channel quality is good. A lossy compression standard, for example, H.264, may be used to reduce the transmission latency, when the channel quality is poor.

In some embodiments, the encoder 113 may implement one or more different codec algorithms. The selection of the codec algorithm may be based on the encoding complexity, encoding speed, encoding ratio, encoding efficiency, and/or the like. For example, a faster codec algorithm may be performed in real-time on low-end hardware. A high encoding ratio may be desirable for a transmission channel with a small bandwidth.

In some embodiments, the encoder 113 may perform intra-encoding (also referred to as intra-frame encoding, i.e., encoding based on information in a same image frame), inter-encoding (also referred to as inter-frame encoding, i.e., encoding based on information from different image frames), or both intra-encoding and inter-encoding on the images captured by the image capturing device 111. For example, the encoder 113 may perform intra-encoding on some frames and inter-encoding on some other frames of the images captured by the image capturing device 111. An image frame refers to a complete image. Hereinafter, the terms “frame”, “image” and “image frame” are used interchangeably. A frame subject to intra-encoding is also referred to as an intra-coded frame or simply intra-frame, and a frame subject to inter-encoding is also referred to as an inter-coded frame or simply inter-frame. In some embodiments, a block, e.g., a macroblock (MB), of a frame can be intra-encoded and thus be referred to as an intra-coded block or intra block, or can be inter-encoded and thus be referred to as an inter-coded block or inter block. For example, in the periodic intra-encoding scheme, intra-frames can be periodically inserted in the encoded bitstream and image frames between the intra-frames can be inter-encoded. Similarly, in the periodic intra-refresh scheme, intra macroblocks (MBs) can be periodically inserted in the encoded bitstream and the MBs between the intra MBs can be inter-encoded.

In some other embodiments, the encoder 113 may further perform at least one of encryption, error-correction encoding, format conversion, or the like. For example, when the images captured by the image capturing device 111 contains confidential information, the encryption may be performed before transmission or storage to protect confidentiality.

The first wireless transceiver 115 includes a wireless transmitter and a wireless receiver, and is configured to have two-way communications capability, i.e., can both transmit and receive data. In some embodiments, the wireless transmitter and the wireless receiver may share common circuitry. In some other embodiments, the wireless transmitter and the wireless receiver may be separate parts sharing a single housing. The first wireless transceiver 115 may work in any suitable frequency band, for example, the microwave band, millimeter-wave band, centimeter-wave band, optical wave band, or the like.

The first wireless transceiver 115 is configured to obtain the encoded bitstream from the encoder 113 and transmit the encoded bitstream to the receiving terminal 150 over the wireless channel 130. In some embodiments, the first wireless transceiver 115 is also configured to send the resolution change information to the receiving terminal 150 over the wireless channel 130, under the control of the adaptive controller 117. In some other embodiments, the first wireless transceiver 115 is further configured to receive the feedback information, for example, the channel information, from the receiving terminal 150 over the wireless channel 130, and send the feedback information to the adaptive controller 117.

The adaptive controller 117 is configured to obtain the feedback information from the first wireless transceiver 115 and adaptively control the image capturing device 111, the encoder 113, and/or the first wireless transceiver 115, according to the feedback information. The feedback information may include, but is not limited to, the channel information indicating the current channel conditions, e.g., the SNR, SINR, BER, CQI, transmission latency, channel bandwidth, and/or the like. That is, the adaptive controller 117 can control the image capturing device 111, the encoder 113, and/or the first wireless transceiver 115 to adapt to the change of the current channel conditions. For example, the adaptive controller 117 can adjust the capture resolution of the image capturing device 111, and an encoding rate and encoding scheme of the encoder 113, according to the channel information.

In some embodiments, the adaptive controller 117 may include a processor and a memory. The processor can include any suitable hardware processor, such as a microprocessor, a micro-controller, a central processing unit (CPU), a network processor (NP), a digital signal processor (DSP), an application specific integrated circuit (ASIC), a field-programmable gate array (FPGA), or another programmable logic device, discrete gate or transistor logic device, discrete hardware component. The memory stores computer program codes that, when executed by the processor, control the processor to control the image capturing device 111, the encoder 113, and/or the first wireless transceiver 115 to perform an image processing method consistent with the disclosure, such as one of the exemplary image processing methods described below, and/or an encoding method consistent with the disclosure, such as one of the exemplary encoding methods described below. In some embodiments, the computer program codes also control the processor to perform some or all of the encoding functions that can be performed by the encoder 113 described above. That is, in these embodiments, instead of or in addition to the dedicated encoder 113, the processor of the adaptive controller 117 can perform some or all of the encoding functions of the method consistent with the disclosure. The memory can include a non-transitory computer-readable storage medium, such as a random access memory (RAM), a read only memory, a flash memory, a volatile memory, a hard disk storage, or an optical medium.

According to the disclosure, the image capturing device 111, the encoder 113, the first wireless transceiver 115, and the adaptive controller 117 can be separate devices, or any two or more of them can be integrated in one device. In some embodiments, the image capturing device 111, the encoder 113, the first wireless transceiver 115, and the adaptive controller 117 are separate devices that can be connected or coupled to each other. For example, the image capturing device 111 can be a camera, a camcorder, or a smartphone having a camera function. The encoder 113 can be an independent device including a processor and a memory, and is coupled to the image capturing device 111, the first wireless transceiver 115, and the adaptive controller 117 through wired or wireless means. The memory coupled to the processor may be configured to store instructions and data. For example, the memory may be configured to store the images captured by the image capturing device 111, the encoded bitstream, computer executable instructions for implementing the encoding processes, or the like. The processor can be any type of processor and the memory can be any type of memory. The disclosure is not limited thereto. The first wireless transceiver 115 can be an independent device combining wireless transmitter/receiver in a single package. The adaptive controller 117 can be an electronic control device coupled to the image capturing device 111, the encoder 113, and the first wireless transceiver 115 through wired or wireless means.

In some other embodiments, any two of the image capturing device 111, the encoder 113, the first wireless transceiver 115, and the adaptive controller 117 can be integrated in a same device. For example, the encoder 113 and the adaptive controller 117 may be parts of a same processing device including a processor and a memory. The processor can include any suitable hardware processor, such as a CPU, a DSP, or the like. The memory may be configured to store instructions and data. The memory can include a non-transitory computer-readable storage medium, such as a random access memory (RAM), a read only memory, a flash memory, a volatile memory, a hard disk storage, or an optical media. In this example, the processing device can further include one or more electrical interfaces (either wired or wireless) for coupling to the image capturing device 111 and the first wireless transceiver 115.

In some other embodiments, the image capturing device 111, the encoder 113, the first wireless transceiver 115, and the adaptive controller 117 are integrated in a same electronic device. For example, the image capturing device 111 may include an image sensor and a lens or a lens set of the electronic device. The encoder 113 may be implemented by a single-chip encoder, a single-chip codec, an image processor, an image processing engine, or the like, which is integrated in the electronic device. The first wireless transceiver 115 may be implemented by an integrated circuit, a chip, or a chipset that is integrated in the electronic device. The adaptive controller 117 may include a control circuit of the electronic device that is configured to control the image capturing device 111, the encoder 113, and/or the first wireless transceiver 115. For example, the electronic device may be a smartphone having a built-in camera and a motherboard that integrates the encoder 113, the first wireless transceiver 115, and the adaptive controller 117.

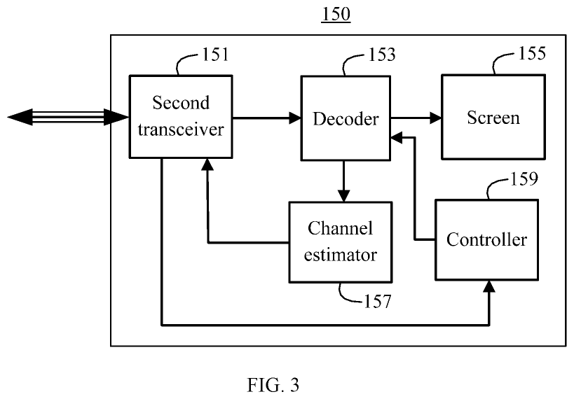

FIG. 3 is a schematic diagram showing an exemplary receiving terminal 150 consistent with the disclosure. The receiving terminal 150 includes a second wireless transceiver 151, a decoder 153, a screen 155, a channel estimator 157, and a controller 159. The channel estimator 157 is coupled to the second wireless transceiver 151 and the decoder 153. The decoder 153 is also coupled to the second wireless transceiver 151, the screen 155, and the controller 159. The controller 159 is further coupled to the second wireless transceiver 151.

The second wireless transceiver 151 is configured to receive the encoded bitstream from the transmitting terminal 110 over the wireless channel 130 and send the encoded bitstream to the decoder 153 for decoding. In some embodiment, the second wireless transceiver 151 is also configured to receive the resolution change information from the first wireless transceiver 115 in the transmitting terminal 110 over the wireless channel 130. In some other embodiments, the second wireless transceiver 151 is further configured to obtain the feedback information, for example, the channel information, from the channel estimator 157 and transmit the feedback information to the transmitting terminal 110 over the wireless channel 130.

The second wireless transceiver 151 includes a wireless transmitter and a wireless receiver, and is configured to have two-way communications capability. In some embodiments, the wireless transmitter and the wireless receiver may share common circuitry. In some other embodiments, the wireless transmitter and the wireless receiver may be separate parts sharing a single housing. The second wireless transceiver 151 can work in a same frequency band as that used in the first wireless transceiver 115 in the transmitting terminal 110. For example, if the first wireless transceiver 115 uses the microwave band, the second wireless transceiver 151 works in the corresponding microwave band. If the first wireless transceiver 115 uses optical wave band, the second wireless transceiver 151 works in the corresponding optical wave band.

The decoder 153 is configured to obtain the encoded bitstream from the second wireless transceiver 151 and decode the encoded bitstream to recover the images captured by the image capturing device 111. The decoder 153 can support the video encoding standard that is used by the encoder 113 in the transmitting terminal 110. For example, if the encoder 113 uses the H.264 standard, the decoder 153 can be configured to support the H.264 standard. In some embodiments, the decoder 153 may include one or more different codecs. The decoder 153 can select a codec corresponding to the codec used by the encoder 113. For example, if the encode uses an H.261 video codec, the decoder 153 can select the corresponding H.261 video codec for decoding.

In some embodiments, the decoder 153 can perform intra-decoding (also referred to as intra-frame decoding, i.e., decoding based on information in a same image frame), inter-decoding (also referred to as inter-frame decoding, i.e., decoding based on information from different image frames), or both intra-decoding and inter-decoding. Whether the intra-decoding or the inter-decoding is applied to an image or a block of an image in the decoder 153 can be based on an encoding scheme used by the encoder 113 in the transmitting terminal 110. For example, if the encoder 113 in the transmitting terminal 110 applied the intra-encoding to a frame or a block of an image, the decoder 153 can use the intra-decoding to recover the frame or the block of the image from the encoded bitstream. If the encoder 113 in the transmitting terminal 110 applied the inter-encoding to a frame or a block of an image, the decoder 153 can use the inter-decoding to recover the frame or the block of the image from the encoded bitstream.

In some other embodiments, the decoder 153 may further perform at least one of decryption, error-correction decoding, format conversion, or the like. For example, when the encryption is performed to protect confidentiality by the encoder 113 in the transmitting terminal 110, the decryption can be performed by the decoder 153 in the receiving terminal 150.

The screen 155 is configured to display the recovered image and/or other information, for example, data and time information about when the images are received. The recovered image can occupy a portion of the screen or the entire screen. In some embodiments, the screen 155 can include a touch panel for receiving a user input. The user can touch the screen 155 with an external object, such as a finger of the user or a stylus. In some embodiments, the user can adjust image parameters, such as brightness, contrast, saturation, and/or the like, by touching the screen 155. For example, the user can scroll vertically on the image to select a parameter, then swipe horizontally to change the value of the parameter.

The channel estimator 157 is configured to obtain the channel information through channel estimation. The channel information may include, but is not limited to, e.g., the SNR, SINR, BER, CQI, transmission latency, channel bandwidth, and/or the like. The channel information can be estimated using pilot data and/or received data based on different channel estimation schemes. The pilot data refers to a data pattern transmitted with data and known to both the transmitting terminal 110 and the receiving terminal 150. The channel estimation scheme can be chosen according to the required performance, computational complexity, time-variation of the channel, and/or the like.

For example, training-based channel estimation uses the pilot data for channel estimation, which provides good performance but the transmission efficiencies are reduced due to the required overhead of pilot data. The least square (LS) and the minimum mean square error (MMSE) are generally used for determining a channel estimate Ĥ. The LS estimates the channel estimate Ĥ by minimizing the sum of the squared errors between the pilot data and the received pilot data. The MMSE estimates the channel estimate Ĥ by minimizing the mean square error (MSE). The channel parameters, such as the SNR, SINR, BER, FER, CQI, and/or the like, can be calculated based on the channel estimate Ĥ. As another example, blind channel estimation utilizes statistical properties of the received data for channel estimation without the use of the pilot data. The blind channel estimation has an advantage of not incurring an overhead of the pilot data, but the performance thereof is usually worse than the training-based channel estimation. Furthermore, the blind channel estimation generally needs a large number of received data to extract statistical properties.

The controller 159 is configured to control the decoder 153 according to the resolution change information. In some embodiments, the controller 159 may include a processor and a memory. The processor can include any suitable hardware processor, such as a microprocessor, a micro-controller, a central processing unit (CPU), a network processor (NP), a digital signal processor (DSP), an application specific integrated circuit (ASIC), a field-programmable gate array (FPGA), or another programmable logic device, discrete gate or transistor logic device, discrete hardware component. The memory stores computer program codes that, when executed by the processor, control the processor to control the decoder 153 to perform an image recovering method consistent with the disclosure, such as one of the exemplary image recovering methods described below, and/or a decoding method consistent with the disclosure, such as one of the exemplary decoding methods described below. In some embodiments, the computer program codes also control the processor to perform some or all of the decoding functions that can be performed by the decoder 153 described above and/or to perform some or all of the channel estimation functions that can be performed by the channel estimator 157 described above. That is, in these embodiments, instead of or in addition to the dedicated decoder 153 and or the dedicated channel estimator 157, the processor of the controller 159 can perform some or all of the decoding functions and/or some or all of the channel estimation functions of the method consistent with the disclosure. The memory can include a non-transitory computer-readable storage medium, such as a random access memory (RAM), a read only memory, a flash memory, a volatile memory, a hard disk storage, or an optical medium.

According to the disclosure, the second wireless transceiver 151, the decoder 153, the screen 155, the channel estimator 157, and the controller 159 can be separate devices, or any two or more of them can be integrated in one device. In some embodiments, the second wireless transceiver 151, the decoder 153, the screen 155, the channel estimator 157, and the controller 159 are separate devices that can be connected or coupled to each other. For example, the second wireless transceiver 151 can be an independent device combining wireless transmitter/receiver in a single package. The decoder 153 can be an independent device including a processor and a memory, and is coupled to the second wireless transceiver 151, the screen 155, the channel estimator 157, and the controller 159 through wired or wireless means. The memory coupled to the processor may be configured to store instructions and data. For example, the memory may be configured to store the encoded bitstream from the transmitting terminal 110, recovered images, and computer executable instructions for implementing the decoding processes, or the like. The processor can be any type of processor and the memory can be any type of memory. The disclosure is not limited thereto. The channel estimator 117 can be an independent device including a processor and a memory, and is coupled to the second wireless transceiver 151 and the decoder 153 through wired or wireless means. The memory coupled to the processor can be configured to store computer executable instructions that, when executed by the processor, implement a channel estimation algorithm to estimate the current channel conditions. The controller 159 can be an electronic control device coupled to the second wireless transceiver 151 and the decoder 153 through wired or wireless means.

In some other embodiments, any two of the second wireless transceiver 151, the decoder 153, the screen 155, the channel estimator 157, and the controller 159 can be integrated in a same device. For example, the controller 159 and the decoder 153 may be parts of a same processing device including a processor and a memory. The processor can include any suitable hardware processor, such as a CPU, a DSP, or the like. The memory stores computer program codes that, when executed by the processor, control the processor to perform an image processing method consistent with the disclosure, such as one of the exemplary image processing methods described below. The memory can include a non-transitory computer-readable storage medium, such as a random access memory (RAM), a read only memory, a flash memory, a volatile memory, a hard disk storage, or an optical media. In this example, the processing device can further include one or more electrical interfaces (either wired or wireless) for coupling to the second wireless transceiver 151, the screen 155, and the channel estimator 157.

In some other embodiments, the second wireless transceiver 151, the decoder 153, the screen 155, the channel estimator 157, and the controller 159 are integrated in a same electronic device. For example, the second wireless transceiver 151 may be implemented by an integrated circuit, a chip, or a chipset that is integrated in the electronic device. The decoder 153 may be implemented by a single-chip decoder, a single-chip codec, an image processor, an image processing engine, or the like, which is integrated in the electronic device. The channel estimator 157 may be implemented by a processor that is integrated in the electronic device. The controller 159 may include a control circuit of the electronic device that is configured to control the decoder 153. For example, the electronic device may be a tablet having a motherboard that integrates the second wireless transceiver 151, the decoder 153, the channel estimator 157, and the controller 159.

Exemplary image processing methods consistent with the disclosure will be described in more detail below. An image processing method consistent with the disclosure can be implemented in a transmitting terminal of a wireless transmission system consistent with the disclosure, such as the transmitting terminal 110 of the wireless transmission system 100 described above.

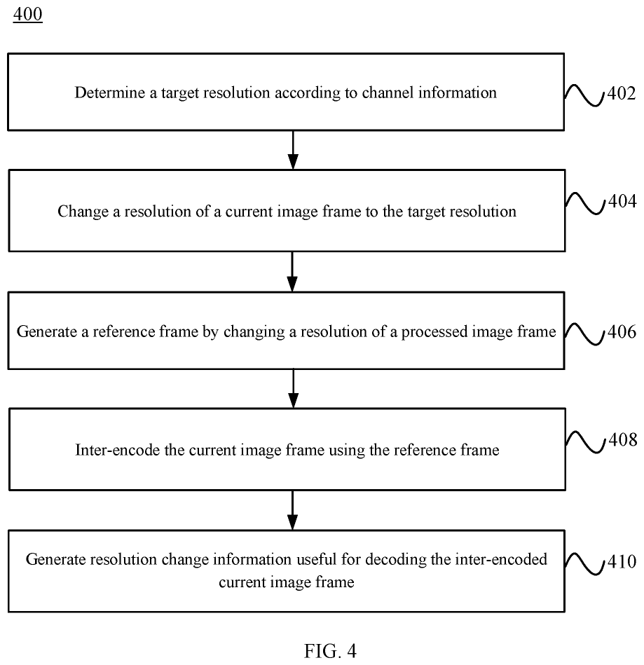

FIG. 4 is a flow chart showing an exemplary image processing method 400 consistent with the disclosure. According to the image processing method 400, an adaptive controller, such as the adaptive controller 117 in the transmitting terminal 110 described above, can change a capture resolution of an image capturing device, such as the image capturing device 111 in the transmitting terminal 110 described above, and a resolution of a reconstructed past frame, according to channel information, which is obtained by a channel estimator, such as the channel estimator 157 of the receiving terminal 150 described above. The reconstructed past frame refers to a frame reconstructed from a previously inter-encoded frame that is obtained by inter-encoding a past frame (a neighboring frame of a current frame). The adaptive controller can inter-encode or control an encoder, such as the encoder 113 of the transmitting terminal 110 described above, to inter-encode the current frame with reference to the reconstructed past frame after the resolution of the reconstructed past frame is changed. That is, when the resolution of the current frame needs to be changed in response to the change of the channel conditions, the resolution of the reconstructed past frame can be changed accordingly to generate a reference frame for the current frame, such that the current frame can be inter-encoded. Therefore, a smooth transmission can be guaranteed regardless of the fluctuations of the channel conditions. The overall perceptual quality of a video can be enhanced and the user experience can be improved.

As shown in FIG. 4, at 402, a target resolution is determined according to the channel information. The target resolution refers to a control target of the resolution of an image to be transmitted, which represents an expected resolution of the image to be transmitted under the current channel conditions. The channel information includes one or more of channel parameters representing the current channel conditions, such as, a SNR, a SINR, a BER, a CQI, a transmission latency, a channel bandwidth, and/or the like.

In some embodiments, the target resolution can be determined according to an expected transmission latency and the current channel bandwidth. That is, a resolution using which the expected transmission latency can be achieved at the current channel bandwidth can be determined to be the target resolution. For example, a maximum bit rate at which the data or bitstream can be transmitted at the current channel bandwidth can be determined based on, for example, Nyquist's formulae. An expected frame rate, i.e., an expected frequency at which an image frame is received, can be calculated based on the expected transmission latency that is the reciprocal of the expected frame rate. Therefore, the target resolution can be calculated by dividing the expected frame rate by the maximum bit rate at the current channel bandwidth.

In some embodiments, the target resolution can be selected from a plurality of preset resolutions. For example, the plurality of preset resolutions can be a plurality of capture resolutions that an image sensor supports. The target resolution may be one of the plurality of preset resolutions using which the transmission latency at the current bandwidth is closest to the expected transmission latency. In some embodiments, the target resolution may be one of the plurality of preset resolutions using which the transmission latency at the current bandwidth is not more than and is closest to the expected transmission latency. In some embodiments, the target resolution may be one of the plurality of preset resolutions using which the difference between the transmission latency at the current bandwidth and the expected transmission latency is within a preset range. Higher resolutions may correspond to higher image qualities. Therefore, the highest resolution among the multiple preset resolutions using which the difference between the transmission latency at the current bandwidth and the expected transmission latency is within a preset range can be selected when the expected transmission latency is satisfied.

In some embodiments, the target resolution can be determined according to a resolution-cost function. That is, a resolution that minimizes the resolution-cost function can be determined as the target resolution. The resolution-cost function can weigh a tradeoff between BER and the transmission latency. For example, the resolution-cost function may be as follows:

Cost=A×BER+B×transmission latency

where Cost represents the cost, A and B represent weights, and the transmission latency=1/(bit rate×resolution).

The transmission latency is inversely correlated to the resolution and the bit rate, and the BER is positively correlated to the resolution and the bit rate. According to the requirements of different application scenarios, the values of A and B can be adjusted to bias towards the requirement of the transmission latency or the requirement of the BER, e.g., the values of A and B can be adjusted to give more weight to the transmission latency or to the BER in the calculation of Cost.

In some embodiments, when the target resolution can be selected from the plurality of preset resolutions, the target resolution may be one of the plurality of preset resolutions with the smallest value of the resolution-cost function.

In some embodiments, the target resolution can be determined based on a channel information table with a preset mapping scheme between one or more channel information values and resolutions. The target resolution that matches the one or more channel information values can be obtained by perform a table lookup. For example, the target resolution can be determined based on a channel information table mapping BERs and transmission latencies to resolutions. The preset mapping scheme is to minimize the resolution-cost function described above.

At 404, a resolution of a current image frame is changed to the target resolution. The current image frame can be a frame to be transmitted.

In some embodiments, changing the resolution of the current image frame can be accomplished by adjusting the capture resolution of the image sensor. That is, the current image frame can be captured after the capture resolution of the image sensor is changed to the target resolution, and hence the current image frame captured by the image sensor can have a resolution that equals the target resolution.

In some embodiments, the image sensor may support a plurality of capture resolutions. In these embodiments, the plurality of capture resolutions are set to be the plurality of preset resolutions used in the process at 402, such that the target resolution determined by the process at 402 can be one of the plurality of capture resolutions. The one of the plurality of capture resolutions that equals the target resolution is selected for capturing the current image frame.

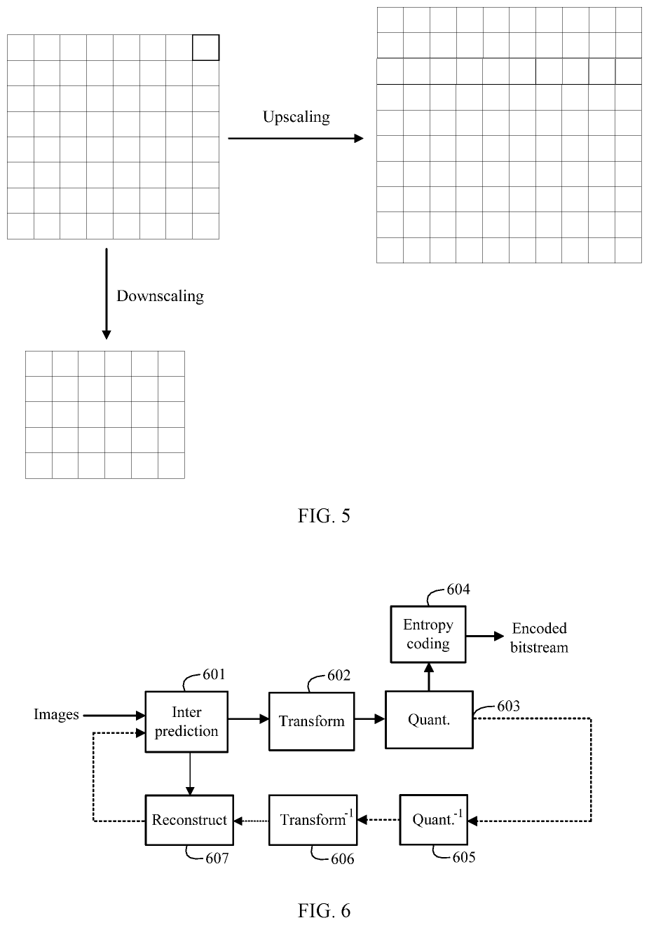

In some other embodiments, when the target resolution is higher than the capture resolution, the current image frame can be upscaled to the target resolution. FIG. 5 schematically shows an example of changing the resolution of an image frame consistent with the disclosure. As shown in FIG. 5, upscaling an image frame refers to converting the image frame from a lower resolution to a higher resolution. The current image frame can be upscaled to the target resolution by interpolating one or more new pixels into the current image frame. Any suitable interpolation algorithm can be used here, such as nearest-neighbor interpolation, bilinear interpolation, bicubic interpolation, Lanczos interpolation, edge-directed interpolation, machine-learning-based interpolation, or the like. For example, nearest-neighbor interpolation replaces a pixel with multiple pixels of a same value. As another example, bilinear interpolation takes a weighted average of pixel values of the closest 2×2 neighborhood pixels surrounding an interpolating position. As another example, Lanczos interpolation uses a low-pass filter to smoothly interpolate a new pixel value between pixel values of two neighborhood pixels.

In some other embodiments, when the target resolution is lower than the capture resolution, the current image frame can be downscaled to the target resolution. As shown in FIG. 5, downscaling an image frame refers to converting the image frame from a higher resolution to a lower resolution. The current image frame can be downscaled to the target resolution by using any suitable 2D filter, such as bilateral filter, Lanczos filter, sinc filter, Gaussian kernel filter, or the like.

At 406, a reference frame is generated by changing a resolution of a processed image frame. The processed image frame may include a frame reconstructed from a previously inter-encoded frame that is obtained by inter-encoding a past frame (a neighboring frame of the current frame). The processed image frame may have a resolution different from the target resolution. In the present disclosure, the processed image frame can also be referred to as a “reconstructed first frame” and correspondingly, the current image frame can also be referred to as a “second image frame.” The previously inter-encoded frame can also be referred to as an “encoded first frame” and the past frame can also be referred to as “a first frame.”

In some embodiments, when the target resolution is higher than the resolution of the processed image frame, the processed image frame can be upscaled to the target resolution. In some other embodiments, when the target resolution is lower than the resolution of the processed image frame, the processed image frame can be downscaled to the target resolution. The upscaling and downscaling processes of the processed image frame are similar to the upscaling and downscaling processes of the current image frame described above, respectively. The detailed description thereof is omitted here.

In some embodiments, multiple reference frames can be generated by changing the resolution of multiple image frames reconstructed from a plurality of previously inter-encoded frames to the target resolution. The plurality of previously inter-encoded frames can be obtained by inter-encoding multiple past frames. Some or all of the multiple reference frames can be selected to use.

At 408, the current image frame is inter-encoded using the reference frame. In the present disclosure, an inter-encoded current image frame obtained by inter-encoding the current image frame can also be referred to as an “encoded second frame.”

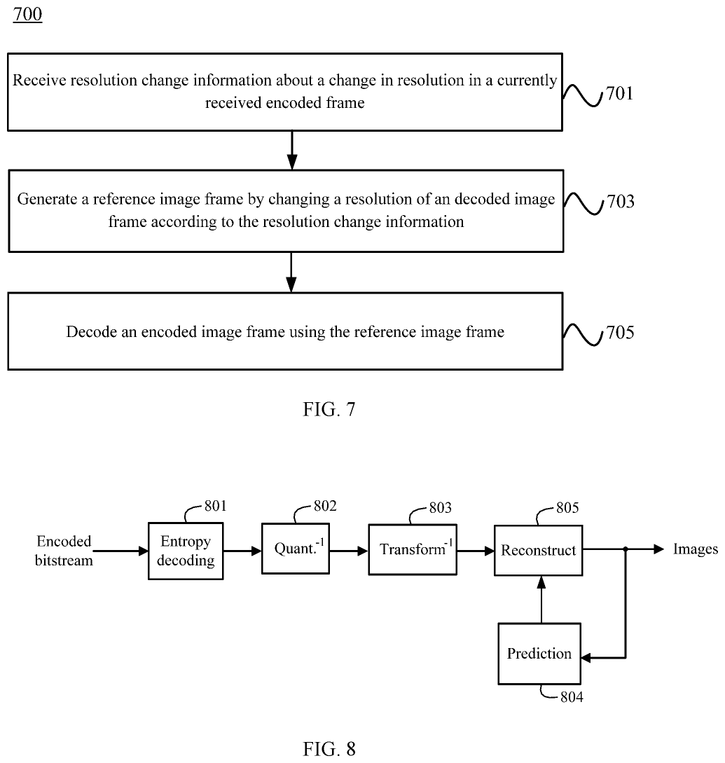

FIG. 6 is a schematic diagram showing inter-encoding and reconstruction processes consistent with the disclosure. As shown in FIG. 6, the inter-encoding process includes an inter-prediction process 601, a transformation process 602, a quantization process 603, and an entropy encoding process 604, shown by a “forward path” connected by solid-line arrows in FIG. 6. Any suitable video encoding standard, such as WMV, SMPTE 421-M, MPEG-x (e.g., MPEG-1, MPEG-2, or MPEG-4), H.26x (e.g., H.261, H.262, H.263, or H.264), or another standard can be used here.

The inter-encoding process can be performed on the entire current image frame or a block, e.g., a MB, of the current image frame. The size and type of the block of the image frame may be determined according to the encoding standard that is employed. For example, a fixed-sized MB covering 16×16 pixels is the basic syntax and processing unit employed in H.264 standard. H.264 also allows the subdivision of an MB into smaller sub-blocks, down to a size of 4×4 pixels, for motion-compensation prediction. An MB may be split into sub-blocks in one of four manners: 16×16, 16×8, 8×16, or 8×8. The 8×8 sub-block may be further split in one of four manners: 8×8, 8×4, 4×8, or 4×4. Therefore, when H.264 standard is used, the size of the block of the image frame can range from 16×16 to 4×4 with many options between the two as described above.

In the inter-prediction process 601, an inter-predicted block is generated using a block of the reference frame according to an inter-prediction mode. The inter-prediction mode can be selected from a plurality of inter-prediction modes that are supported by the video encoding standard that is employed. Taking H.264 for an example, H.264 supports all possible combination of inter-prediction modes, such as variable block sizes (e.g., 16×16, 16×8, 8×16, 8×8, 8×4, 4×8, 4×4) used in inter-frame motion estimation, different inter-frame motion estimation modes (e.g., use of integer, half, or quarter pixel motion estimation), and multiple reference frames.

In some embodiments, the inter-prediction mode can be a best inter-predication mode for the block of the current image frame among the plurality of inter-predication modes. Any suitable prediction mode selection technique may be used here. For example, H.264 uses a Rate-Distortion Optimization (RDO) technique to select the inter-prediction mode that has a least rate-distortion (RD) cost for the current MB.

In some embodiments, two or more blocks from the multiple reference images may be used to generate the inter-predicted block. For example, H.264 supports multiple reference frames, e.g., up to 32 reference frames including 16 past frames and 16 future frames. The prediction block can be created by a weighted sum of blocks from the reference frames.

The inter-predicted block is subtracted from the block of the current image frame to generate a residual block.

In the transformation process 602, the residual block is transformed from the spatial domain into a representation in the frequency domain (also referred to as spectrum domain), in which the residual block can be expressed in terms of a plurality of frequency-domain components, such as a plurality of sine and/or cosine components. Coefficients associated with the frequency-domain components in the frequency-domain expression are also referred to as transform coefficients. Any suitable transformation method, such as a discrete cosine transform (DCT), a wavelet transform, or the like, can be used here. Taking H.264 as an example, the residual block is transformed using a 4×4 or 8×8 integer transform derived from the DCT.

In the quantization process 603, the transform coefficients are quantized to provide quantized transform coefficients. For example, the quantized transform coefficients may be obtained by dividing the transform coefficients with a quantization step size (Qₛₜₑₚ).

In the entropy encoding process 604, the quantized transform coefficients are converted into binary codes and thus an inter-coded block in the form of bitstream is obtained. Any suitable entropy encoding technique may be used, such as Huffman coding, Unary coding, Arithmetic coding, Shannon-Fano coding, or the like. For example, context-adaptive variable-length coding (CAVLC) is used in H.264 standard to generate bitstreams. In some embodiments, the quantized transform coefficients may be reordered before being subject to the entropy encoding.

Referring again to FIG. 4, at 410, the resolution change information useful for decoding the inter-encoded current image frame is generated. In some embodiments, the resolution change information may include a resolution changing flag and the target resolution. The resolution changing flag indicates whether the resolution of the current image is changed. For example, the resolution changing flag can have two states “0” and “1”, and the state “1” represents the resolution of the current image has changed and the state “0” represents the resolution of the current image does not change. In some embodiments, the resolution change information may be carried by a plurality of channel-associated signaling bits.

In some embodiments, the image processing method 400 can also include processes for generating the processed image frame by reconstructing the previously inter-encoded frame before the process at 406. As shown in FIG. 6, the process for reconstructing an inter-encoded image frame includes an inverse quantization process 605, an inverse transformation process 606, and a reconstruction process 607, shown by an “inverse path” connected by dashed-line arrows in FIG. 6. In the processes described below, it is assumed that the past frame has been previously inter-encoded according to the “forward path” shown in FIG. 6 to obtain the previously inter-encoded frame and corresponding quantized transform coefficients.

In the inverse quantization process 605, the quantized transform coefficients corresponding to the previously inter-encoded frame are multiplied by the quantization step size (Qₛₜₑₚ) to obtain reconstructed transform coefficients. In the inverse transformation process 606, the reconstructed transform coefficients are inversely transformed to generate a reconstructed residual block. In the reconstruction process 607, the reconstructed residual block is added to an inter-predicted block (obtained by inter-predicting a block of the past frame) to reconstruct a block of the processed image frame.

Exemplary image recovering methods consistent with the disclosure will be described in more detail below. An image recovering method consistent with the disclosure can be implemented in a receiving terminal of a wireless transmission system consistent with the disclosure, such as the receiving terminal 150 of the wireless transmission system 100 described above.

FIG. 7 is a flow chart showing an exemplary image recovering method 700 consistent with the disclosure. According to the image recovering method 700, a controller, such as the controller 159 of the receiving terminal 150 described above, can change a resolution of a decoded image frame according to resolution change information that is transmitted from a transmitting terminal, such as the transmitting terminal 110 described above. The decoded image frame refers to an image frame recovered from a previously received encoded image frame in the form of an encoded bitstream. The controller can further inter-decode or control a decoder, such as the decoder 153 of the receiving terminal 150 described above, to inter-decode a currently received encoded image frame in the form of an encoded bitstream with reference to the decoded image frame after the resolution of the decoded image frame is changed.

As shown in FIG. 7, at 701, the resolution change information about a change in resolution in the currently received encoded frame are received. In some embodiments, the resolution change information may include a resolution changing flag and a new resolution. The resolution changing flag indicates whether the resolution of the encoded image currently received has changed. For example, the resolution changing flag may have two states “0” and “1”, and the state “1” represents the resolution of the current image has changed and the state “0” represents the resolution of the current image does not change. In some embodiments, the resolution change information can be carried by a plurality of channel-associated signaling bits.

At 703, a reference frame is generated by changing the resolution of the decoded image frame according to the resolution change information. That is, when resolution changing flag indicates that the encoded image frame currently received has changed, the reference frame is generated by changing a resolution of the decoded image frame to the new resolution. The decoded image frame refers to an image frame recovered from a previously received encoded image frame.

In some embodiments, when the resolution of the encoded image frame is higher than the new resolution, the decoded image frame can be upscaled to the new resolution. In some other embodiments, when the resolution of the encoded image frame is lower than the new resolution, the decoded image frame can be downscaled to the new resolution. The upscaling and downscaling processes of the decoded image frame are similar to the upscaling and downscaling processes of the current image frame described above at 404. The detailed description thereof is omitted here.

In some embodiments, multiple reference frames can be generated by changing the resolution of multiple decoded image frames recovered from a plurality of previously received encoded image frames. Some or all of the multiple reference frames can be selected to use.

At 705, the encoded image frame is decoded using the reference frame. The encoded image frame refers to a currently received encoded image frame in the form of an encoded bitstream.

FIG. 8 is a schematic diagram showing an inter-decoding process consistent with the disclosure. As shown in FIG. 8, the inter-decoding process includes an entropy decoding process 801, an inverse quantization process 802, an inverse transformation process 803, a prediction process 804, and a reconstruction process 805.

In the entropy decoding process 801, the encoded image frame is converted into decoded quantized transform coefficients. An entropy decoding technique corresponds to the entropy encoding technique, which is employed for inter-encoding the block of the current image frame at 408, can be used here. For example, when Huffman coding is employed in the entropy encoding process, Huffman decoding can be used in the entropy decoding process. As another example, when Arithmetic coding is employed in the entropy encoding process, Arithmetic decoding can be used in the entropy decoding process.

In the inverse quantization process 802, the decoded quantized transform coefficients are multiplied by the quantization step size (Qₛₜₑₚ) to obtain decoded transform coefficients.

In the inverse transformation process 803, the decoded transform coefficients are inversely transformed to generate a decoded residual block. An inverse transform algorithm corresponds to the transform algorithm, which is employed for inter-encoding the block of the current image frame at 408, may be used. For example, in H.264, the 4×4 or 8×8 integer transform derived from the DCT is employed in the transform process, and hence the 4×4 or 8×8 inverse integer transform can be used in the inverse transform process.

In the prediction process 804, a predicted block is generated using a block of the reference frame according to a prediction mode. A prediction mode corresponds to the inter-prediction mode, which is employed for inter-encoding the block of the current image frame at 408, may be used. The implementation of the prediction process 804 is similar to the implementation of the inter-prediction process 601 described above. The detailed description thereof is omitted here.

In the reconstruction process 805, the decoded residual block is added to the predicted block to recover a block of the encoded image frame.

Exemplary encoding methods consistent with the disclosure will be described in detail below. An encoding method consistent with the disclosure can be implemented in a transmitting terminal of a wireless transmission system consistent with the disclosure, such as the transmitting terminal 110 of the wireless transmission system 100 described above. The encoding method can include or be part of an image processing method consistent with the disclosure.

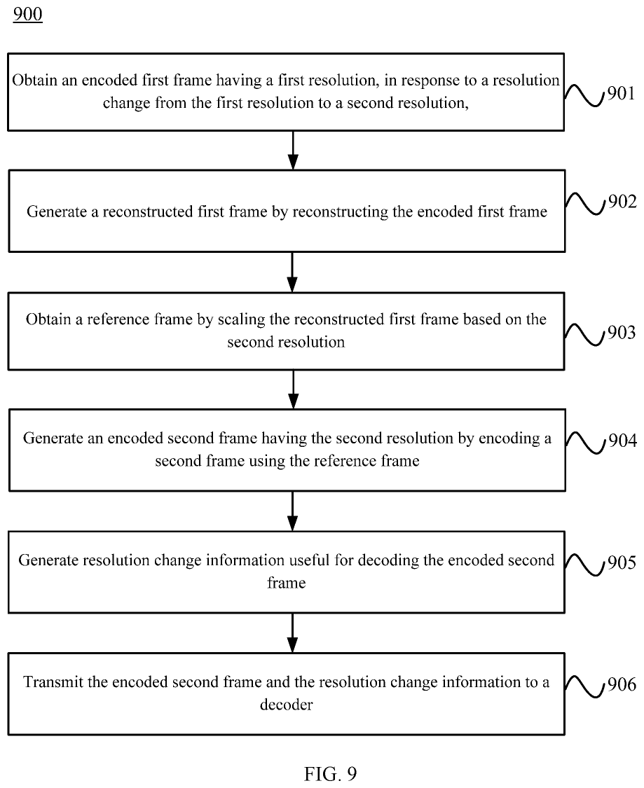

FIG. 9 is a flow chart showing an exemplary encoding method 900 consistent with the disclosure. According to the encoding method 900, an adaptive controller, for example, the adaptive controller 117 of the transmitting terminal 110 described above, can change a resolution of a reconstructed past frame to obtain a reference frame. The reconstructed past frame refers to a frame reconstructed from a previously inter-encoded frame that is obtained by inter-encoding a past frame (a neighboring frame of a current frame). The adaptive controller can further encode or control an encoder, for example, the encoder 113 of the transmitting terminal 110 described above, to encode a current frame using the reference frame to generate an encoded frame. That is, when the resolution of the current frame changes in response to the change of the channel conditions, the resolution of the reconstructed past frame can be changed accordingly to generate a reference frame for the current frame, such that the current frame can be inter-encoded. Therefore, a smooth transmission can be guaranteed regardless of the fluctuations of the channel conditions. The overall perceptual quality of a video can be enhanced and the user experience can be improved.

As shown in FIG. 9, at 901, in response to a resolution change from a first resolution to a second resolution, an encoded first frame having the first resolution is obtained.

In some embodiments, the encoded first frame may include a previously encoded frame that is obtained by encoding a first frame having the first resolution. The first frame can include a past frame (a neighboring frame of a current frame) having the first resolution or one of a plurality of past frames having the first resolution.

In some embodiments, the encoded first frame can be an inter-encoded frame or an intra-encoded frame. In some other embodiments, the encoded first frame can be an inter-encoded frame including one or more intra-encoded blocks.

At 902, a reconstructed first frame is generated by reconstructing the encoded first frame.

In some embodiments, when the encoded first frame is the inter-encoded frame, as shown in FIG. 6, the process for reconstructing the encoded first frame includes an inverse quantization process 605, an inverse transformation process 606, and a reconstruction process 607, shown by an “inverse path” connected by dashed-line arrows in FIG. 6. In the inverse quantization process 605, the quantized transform coefficients corresponding to the encoded first frame are multiplied by the quantization step size (Qₛₜₑₚ) to obtain reconstructed transform coefficients. In the inverse transformation process 606, the reconstructed transform coefficients are inversely transformed to generate a reconstructed residual block. In the reconstruction process 607, the reconstructed residual block is added to an inter-predicted block (obtained by inter-predicting a block of the first frame) to reconstruct a block of the reconstructed first frame.

In some embodiments, when the encoded first frame is the intra-encoded frame, an inverse quantization process and an inverse transformation process is similar to the inverse quantization process 605 and the inverse transformation process 606 shown in FIG. 6. The detailed description thereof is omitted here. In the reconstruction process, a reconstructed residual block (obtained by performing the inverse quantization process and the inverse transformation process on a block of the encoded first frame) is added to an intra-predicted block (obtained by intra-predicting a block of the first frame) to reconstruct a block of the reconstructed first frame.

In some other embodiments, when the encoded first frame is an inter-encoded frame including one or more intra-encoded blocks, the one or more intra-encoded blocks are inversely quantized and inversely transformed to generate one or more residual blocks and the one or more residual blocks are added to corresponding intra-predicted blocks (obtained by intra-predicting corresponding blocks of the first frame) to reconstruct one or more blocks of the reconstructed first frame. The remaining blocks, i.e., blocks other than the intra-encoded blocks, of the first frame are inversely quantized and inversely transformed to generate residual blocks and the residual blocks (obtained by inter-predicting corresponding blocks of the first frame) are added to corresponding remaining blocks to reconstructed remaining blocks of the reconstructed first frame.

At 903, a reference frame is obtained by scaling the reconstructed first frame based on the second resolution.

In some embodiments, when the first resolution is higher than the second resolution, the reconstructed first frame can be downscaled to the second resolution. In some other embodiments, when the first resolution is lower than the second resolution, the reconstructed first frame can be upscaled to the second resolution. The upscaling and downscaling processes of the reconstructed first frame are similar to the upscaling and downscaling processes of the current image frame described above at 404. The detailed description thereof is omitted here.

At 904, an encoded second frame having the second resolution is generated by encoding a second frame using the reference frame. The second frame refers to a currently received frame that is needed to be encoded. The second frame can have the second resolution.

In some embodiments, the encoded second frame can be generated by inter-encoding the second frame using the reference frame. The inter-encoding process of the second frame is similar to the inter-encoding process of the current image frame described above at 408. The detailed description thereof is omitted here.

At 905, resolution change information useful for decoding the encoded second frame is generated. The generation of the resolution change information is similar to the process at 410. The detailed description thereof is omitted here.

At 906, the encoded second frame and the resolution change information are transmitted to a decoder. The decoder can be, for example, the decoder 153 of the receiving terminal 150.

In some embodiments, the encoded second frame can be carried by any suitable frequency band, for example, the microwave band, millimeter-wave band, centimeter-wave band, optical wave band, or the like, for transmitting to the decoder.

In some embodiments, the resolution change information can be transmitted using a plurality of channel-associated signaling bits.

In some embodiments, information useful for decoding the encoded second frame, such as information for enabling the decoder to recreate the prediction (e.g., selected prediction mode, partition size, and the like), information about the structure of the bitstream, information about a complete sequence (e.g., MB headers), and the like, can also be transmitted to the decoder.

In some embodiments, the encoding method 900 can also include processes for generating the encoded first frame by encoding the first frame. In some embodiments, when the first frame is inter-encoded, the encoded first frame is generated according to the “forward path” shown in FIG. 6, which is similar to the inter-encoding process of the current image frame described above at 408. The detailed description thereof is omitted here.

In some embodiments, when the first frame in intra-encoded, the intra-encoding process is similar to the inter-encoding process, except for using an intra-prediction process to replace the inter-prediction process. The intra-prediction process employs spatial prediction, which exploits spatial redundancy contained within the first frame. Any suitable intra-prediction mode can be used here. For example, H.264 supports nine intra-prediction modes for luminance 4×4 and 8×8 blocks, including 8 directional modes and an intra direct component (DC) mode that is a non-directional mode. In some embodiments, the intra-prediction process can also include a prediction selection process. Any suitable prediction mode selection technique may be used here. For example, H.264 uses a Rate-Distortion Optimization (RDO) technique to select the intra-prediction mode that has a least rate-distortion (RD) cost for the current MB.

In some other embodiments, one or more blocks of the first frame are intra-encoded and the remaining blocks of the first frame are inter-encoded.

Exemplary decoding methods consistent with the disclosure will be described in detail below. A decoding method consistent with the disclosure can be implemented in a receiving terminal of a wireless transmission system consistent with the disclosure, such as the receiving terminal 150 of the wireless transmission system 100 described above. The decoding method can include or be a part of the image recovering method consistent with the disclosure.

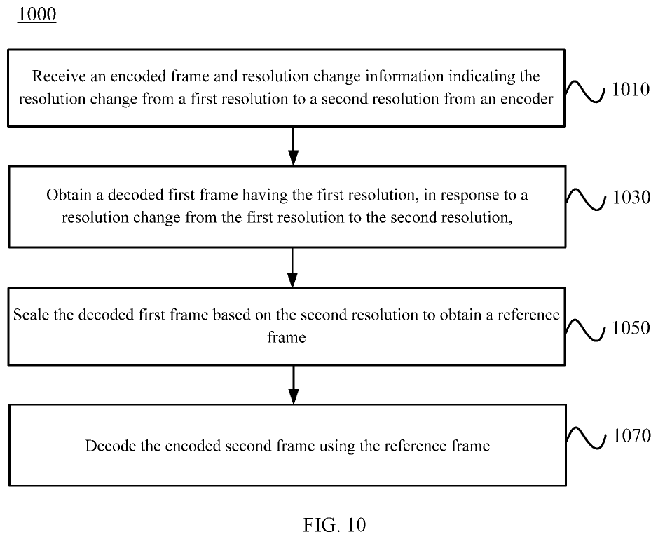

FIG. 10 is a flow chart showing an exemplary decoding method 1000 consistent with the disclosure. According to the decoding method 1000, a controller, such as the controller 159 of the receiving terminal 150 described above, can change a resolution of a decoded image frame according to resolution change information that is transmitted from a transmitting terminal, such as the transmitting terminal 110 described above. The decoded image frame refers to an image frame recovered from a previously received encoded image frame in the form of an encoded bitstream. The controller can further inter-decode or control a decoder, such as the decoder 153 of the receiving terminal 150 described above, to inter-decode a currently received encoded image frame in the form of an encoded bitstream with reference to the decoded image frame after the resolution of the decoded image frame is changed.

As shown in FIG. 10, at 1010, an encoded frame and resolution change information indicating the resolution change from a first resolution to a second resolution are received from an encoder. The encoder can be, for example, the encoder 113 of the transmitting terminal 110.

In some embodiments, the encoded frame can include a currently received encoded frame. In the present disclosure, the encoded frame can also be referred to as an encoded second frame.

In some embodiments, the resolution change information can be carried by a plurality of channel-associated signaling bits.

In some embodiments, information useful for decoding the encoded frame, such as information for enabling the decoder to recreate the prediction (e.g., selected prediction mode, partition size, and the like), information about the structure of the bitstream, information about a complete sequence (e.g., MB headers), and the like, can also be received from the encoder.

At 1030, in response to a resolution change from the first resolution to the second resolution, a decoded first frame having the first resolution is obtained.

In some embodiments, the decoded first frame may include a frame recovered from an encoded first frame having the first resolution. The encoded first frame can include a previously received encoded image frame (neighboring frame of the currently received encoded frame) having the first resolution or one of a plurality of previously received encoded image frames having the first resolution.

In some embodiments, the decoded first frame can be an inter-decoded frame or an intra-decoded frame. In some other embodiments, the decoded first frame can be an inter-decoded frame including one or more intra-decoded blocks.

At 1050, the decoded first frame is scaled based on the second resolution to obtain a reference frame.

In some embodiments, when the first resolution is higher than the second resolution, the decoded first frame can be downscaled to the second resolution. In some other embodiments, when the first resolution is lower than the second resolution, the decoded first frame can be upscaled to the second resolution. The upscaling and downscaling processes of the decoded first frame are similar to the upscaling and downscaling processes of the current image frame described above at 404. The detailed description thereof is omitted here.

At 1070, the encoded second frame is decoded using the reference frame.

In some embodiments, the encoded second frame can be inter-decoded, for example, according to the inter-decoding process shown in FIG. 8. The inter-decoding process of the encoded second frame is similar to the inter-decoding process of the encoded image frame described above at 705. The detailed description thereof is omitted here.

In some embodiments, the decoding method 1000 can also include processes for generating the decoded first frame by decoding the encoded first frame.

In some embodiments, the encoded first frame can be an inter-encoded frame or an intra-encoded frame. In some embodiments, the encoded first frame can be an inter-encoded frame with one or more intra-encoded blocks.

In some embodiments, when the encoded first frame is an inter-encoded frame, the decoded first frame can be generated by inter-decoding the encoded first frame, for example, according to the inter-decoding process shown in FIG. 8. The inter-decoding process of the encoded second frame is similar to the inter-decoding process of the encoded image frame described above at 705. The detailed description thereof is omitted here.

In some embodiments, when the encoded first frame is an intra-encoded frame, the decoded first frame can be generated by intra-decoding the encoded first frame. The intra-decoding process is similar to the inter-decoding process, except for using an intra-prediction process to replace the inter-prediction process.

In some embodiments, when the encoded first frame is an inter-encoded frame with one or more intra-encoded blocks. The one or more intra-encoded blocks of the encoded first frame are intra-decoded and the remaining blocks of the encoded first frame are inter-decoded.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. An image processing method, comprising:
generating a reference frame by changing a resolution of a reconstructed first frame;
inter-encoding a second frame using the reference frame; and
generating resolution change information useful for decoding the encoded second frame.

2. The image processing method according to claim 1, further comprising:
generating the reconstructed first frame by reconstructing an encoded first frame.

3. The image processing method according to claim 1, further comprising:
determining to change the resolution of the reconstructed first frame in response to a change in channel conditions.

4. The image processing method according to claim 3, wherein generating the reference frame by changing the resolution of the reconstructed first frame comprises:
changing the resolution of the reconstructed first frame according to a target resolution.

5. The image processing method according to claim 4, wherein generating the reference frame by changing the resolution of the reconstructed first frame comprises:
downscaling the reconstructed first frame according to the target resolution, when the resolution of the reconstructed first frame is higher than the target resolution.

6. The image processing method according to claim 4, wherein generating the reference frame by changing the resolution of the reconstructed first frame comprises:
upscaling the reconstructed first frame according to the target resolution, when the resolution of the reconstructed first frame is lower than the target resolution.

7. The image processing method according to claim 4, further comprising:
determining the target resolution according to the channel conditions.

8. The image processing method according to claim 4, further comprising:
changing the resolution of the second frame according to the target resolution before inter-encoding the second frame.

9. The image processing method according to claim 1, wherein the resolution change information comprises the target resolution.

10. An image recovering method, comprising:
receiving resolution change information about a change in resolution in an encoded frame;
generating a reference frame by changing a resolution of a decoded frame according to the resolution change information; and
decoding the encoded frame according to the reference frame.

11. The image recovering method according to claim 10, wherein the resolution change information comprises a new resolution.

12. The image recovering method according to claim 10, wherein changing the resolution of the decoded frame according to the resolution change information comprises:
downscaling the resolution of the decoded frame according to a new resolution in the resolution change information, when the resolution of the decoded frame is higher than the new resolution.

13. The image recovering method according to claim 10, wherein changing the resolution of the decoded frame according to the resolution change information comprises:
upscaling the resolution of the decoded frame according to a new resolution in the resolution change information, when the resolution of the decoded frame is lower than the new resolution.

14. An encoding method, comprising:
in response to a resolution change from a first resolution to a second resolution, obtaining an encoded first frame having the first resolution;
reconstructing the encoded first frame to generate a reconstructed first frame;
scaling the reconstructed first frame based on the second resolution to obtain a reference frame; and
encoding a second frame using the reference frame to generate an encoded second frame having the second resolution.

15. The encoding method according to claim 14, wherein the resolution change is in response to a change in channel conditions.

16. The encoding method according to claim 14, further comprising:
encoding a first frame to generate the encoded first frame.

17. The encoding method according to claim 14, further comprising:
generating resolution change information useful for decoding the encoded second frame.

18. The encoding method according to claim 14, further comprising:
transmitting the encoded second frame and the resolution change information to a decoder.

19. The encoding method according to claim 14, wherein scaling the reconstructed first frame comprises:
downscaling the reconstructed first frame when the first resolution is higher than the second resolution.

20. The encoding method according to claim 14, wherein scaling the reconstructed first frame comprises:
upscaling the reconstructed first frame when the first resolution is lower than the second resolution.
